(19) United States
(12) Patent Application Publication
(10) Pub. No.: US 2004/0090584 A1
(43) Pub. Date: May 13, 2004

(54) Assembly structure for flat panel display device

(75) Inventor: Che-Kuei Mai, Hsinchu (TW)

Correspondence Address: LOWE HAUPTMAN GOPSTEIN GILMAN & BERNER, LLP, Suite 310, 1700 Diagonal Road, Alexandria, VA, 22314, US

(73) Assignee: TOPPOLY OPTOELECTRONICS CORP.

(21) Appl. No.: 10/423,908

(22) Filed: Apr. 28, 2003

(30) Foreign Application Priority Data
Nov. 12, 2002 (TW) 091133313

(51) Int. Cl. G02F 1/1345

(52) U.S. Cl. 349/149

(57) ABSTRACT

An assembly structure for flat panel display device includes a liquid crystal display device with a back light as well as a liquid crystal display panel thereon, and a system mainboard with a control IC mounted on the system mainboard to control the liquid crystal display device. The liquid crystal display device is on the system mainboard and electrically connected to the system mainboard by the direct wire bonding method.

### BACKGROUND OF THE INVENTION

1. Field of the Invention

The invention relates to a flat display device, more particularly to an assembly structure for flat display device.

2. Description of the Prior Art

Liquid crystal display (LCD) device, which is a par flat display device, is a kind of household electric appliance in nowadays daily life, such as television or monitor of a computer, display screen of camera, display device on a calculator, display screen of watch or mobile phone, display device of controlling system, or display panel of CD player. The liquid crystal display device is widely used, so the assembly of it is quite important. Most of the liquid crystal display devices will be electrically connected to the system mainboard with a flexible printed circuit board (FPC) because the control device to control the liquid crystal display device is on the system mainboard, which is a printed circuit board (PCB) with the essential circuit. Now the control device, the IC made under the semiconductor process, is mounted on the system mainboard.

As illustrated in FIG. 1, there is at least a FPC 102 next to a liquid crystal display device 100. An end of the FPC 102 is electrically connected with the liquid crystal display device 100, and the other end of the FPC 102 is electrically connected with a system mainboard 104 as illustrated in FIG. 2. The liquid crystal display 100 comprises a liquid crystal display panel 110 and a back light 120. The liquid crystal display panel 110 includes a lower transparent substrate 112, a liquid crystal layer 114 on the lower transparent substrate 112, and a upper transparent substrate 116 on the liquid crystal layer 114. The back light 120 includes a light guide plate 122 and a light source 124 located at a lateral end of the light guide plate 122. The liquid crystal display device 100 with the above back light 120 is called the transmission-type liquid crystal display device. An end of the FPC 102 is electrically connected with the lower transparent substrate 112, and the other end is electrically connected with the system mainboard 104 by a connector 108. FIG. 2 shows the advantage of using the FPC 102 since this bonding method can reduce the large assembly size of liquid crystal display device.

The above assembly structure of liquid crystal display device is referred to many patents. For example, U.S. Pat. No. 5,844,733 disclosed the assembly of liquid crystal display device used in the notebook. U.S. Pat. No. 6,181,404 disclosed the application of the rigid connector to connect the liquid crystal display device and the system mainboard. Taiwan patent publication number 476,122 disclosed an assembly method for a flat display device with opaque substrate wherein the liquid crystal display panel is equipped with the PCB and the heat sink. Taiwan patent publication number 422,933 filed by Samsung disclosed a liquid crystal display module with PCB structure. And Taiwan patent publication number 448,337 filed by Seiko-Epson disclosed the embodiment of the elastomer joint to connect an input and a contact of driver circuit.

Another method to connect the liquid crystal display device and the control device on the system mainboard is a chip directly formed on the lower glass substrate by using semiconductor process called as the COG (chip on glass) process. Please refer to U.S. Pat. No. 6,292,248 disclosed the process to fabricate the chip on the typical glass substrate. This process can make the display device lighter and thinner, but the cost of this advanced and complex process is not cheap and the yield of mass production is low.

However, the trend of the daily electric appliance is to minimize the size. It is hard to minimize the size of the flat display device using the above assembly structure. Therefore, we need a new method to finish the object of making the display device lighter and thinner.

### SUMMARY OF THE INVENTION

In the light of the state of the art described above, it is an object of the present invention to provide an assembly structure for flat display device by bonding the liquid crystal display panel to the system mainboard for saving the COG process is immune to the problems of conventional flat display device described above.

It is also an object of this invention to save the FPCs of liquid crystal display panel and back light and several connectors for making the whole display module lighter and thinner.

It is another object of this invention to provide a new assembly structure for flat display device with touch panel for minimizing the size of flat display device with touch panel.

In view of the above and other objects which will become apparent as the description proceeds, there is provided according to a general aspect of the present invention an assembly structure for flat display device which comprises a liquid crystal display device with a back light and a liquid crystal display panel on said back light; and a system mainboard with a control IC mounted thereon to control said liquid crystal display device, wherein said liquid crystal display device is on said system mainboard and said liquid crystal display panel is electrically connected to said system mainboard by a direct bonding method.

Base on the idea described above, wherein said back light includes a light guide plate and a light source located at a lateral end of said light guide plate.

Base on the aforementioned idea, wherein said light source is a line LED light source.

Base on the idea described above, wherein said line LED light source is mounted on said system mainboard.

Base on the aforementioned idea, wherein said liquid crystal device panel includes a first transparent substrate on said back light; a liquid crystal layer on said first transparent substrate; and a second transparent substrate on said liquid crystal layer.

Base on the idea described above, wherein said second transparent substrate is used as said light guide plate of said back light.

Base on the aforementioned idea, wherein said first transparent substrate has at least a fixing hole for fixing said liquid crystal device panel on said system mainboard.

Base on the idea described above, wherein the position of direct bonding said liquid crystal display panel and said system mainboard is between said first transparent substrate and said system mainboard.

Base on the aforementioned idea, wherein said direct bonding method is a wire bonding method.

Base on the idea described above, wherein said direct bonding method is a Ball Grid Array (BGA) bonding method.

Base on the aforementioned idea, wherein said direct bonding method is a bump bonding method.

Base on the idea described above, wherein said liquid crystal display panel includes a first polarizer is between said light source and said light guide plate; and a second polarizer is on said second transparent substrate.

Base on the aforementioned idea, the assembly structure for flat display device further comprises a touch panel on said liquid crystal display panel.

Base on the idea described above, wherein said second polarizer is used as the lower transparent substrate of said touch panel.

Base on the aforementioned idea, wherein said touch panel is directly and electrically connected to said system mainboard by a wire bonding method.

In view of the above and other objects which will become apparent as the description proceeds, there is provided according to a general aspect of the present invention an assembly structure for flat display device which comprises a liquid crystal display device having a back light with a light guide plate and a line LED light source located at a lateral end of said light guide plate; and a liquid crystal display panel on said back light further comprising a first transparent substrate on said back light; a liquid crystal layer on said first transparent substrate; and a second transparent substrate on said liquid crystal layer; and a system mainboard with a control IC mounted thereon to control said liquid crystal display device, wherein said liquid crystal display device is on said system mainboard and said first transparent substrate of said liquid crystal display panel is electrically connected to said system mainboard by a direct bonding method.

Base on the idea described above, wherein said second transparent substrate is used as said light guide plate of said back light.

Base on the aforementioned idea, wherein said line LED light source is mounted on said system mainboard.

Base on the idea described above, wherein said first transparent substrate has at least a fixing hole for fixing said liquid crystal device panel on said system mainboard.

Base on the aforementioned idea, wherein said liquid crystal display panel includes a first polarizer is between said light source and said light guide plate; and a second polarizer is on said second transparent substrate.

Base on the idea described above, wherein said direct bonding method is a wire bonding method.

Base on the aforementioned idea, wherein said direct bonding method is a Ball Grid Array (BGA) bonding method.

Base on the idea described above, wherein said direct bonding method is a bump bonding method.

Base on the aforementioned idea, the assembly structure for flat display device further comprises further comprises a touch panel on said liquid crystal display panel.

Base on the idea described above, wherein said second polarizer is used as the lower transparent substrate of said touch panel.

Base on the aforementioned idea, wherein said touch panel is directly and electrically connected to said system mainboard by a wire bonding method.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a structure view of conventional liquid crystal display panel and flexible printed circuit board;

FIG. 2 illustrates an assembly structure view of conventional liquid crystal display panel and system mainboard;

FIG. 3 illustrates a side structure view of liquid crystal display panel direct bonding to system mainboard according to the embodiment of this invention;

FIG. 4 illustrates a top view of liquid crystal display panel direct bonding to system mainboard according to the embodiment of this invention;

FIG. 5 illustrates a side structure view of liquid crystal display panel with touch panel direct bonding to system mainboard according to the embodiment of this invention; and

FIG. 6 illustrates a top view of liquid crystal display panel with touch panel direct bonding to system mainboard according to the embodiment of this invention.

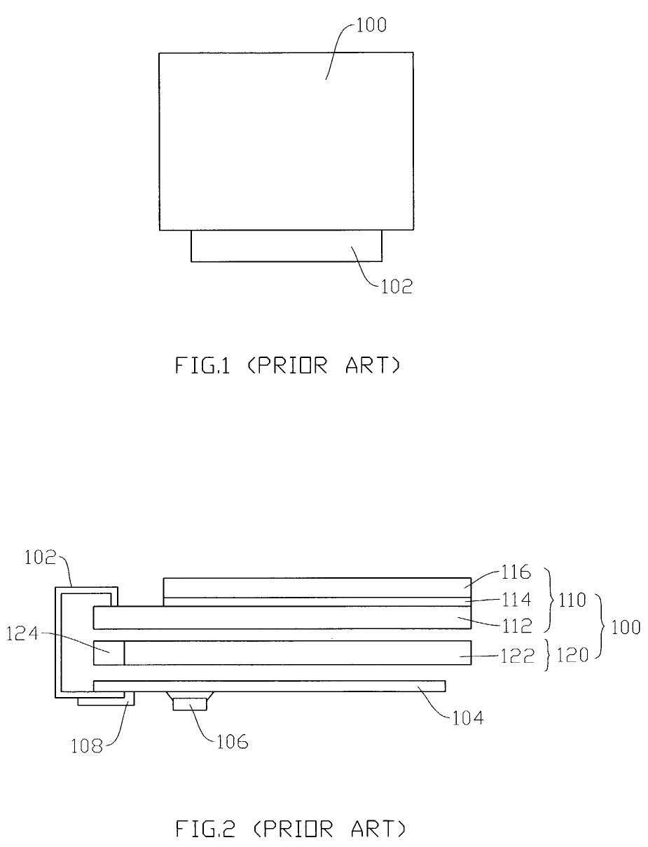

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

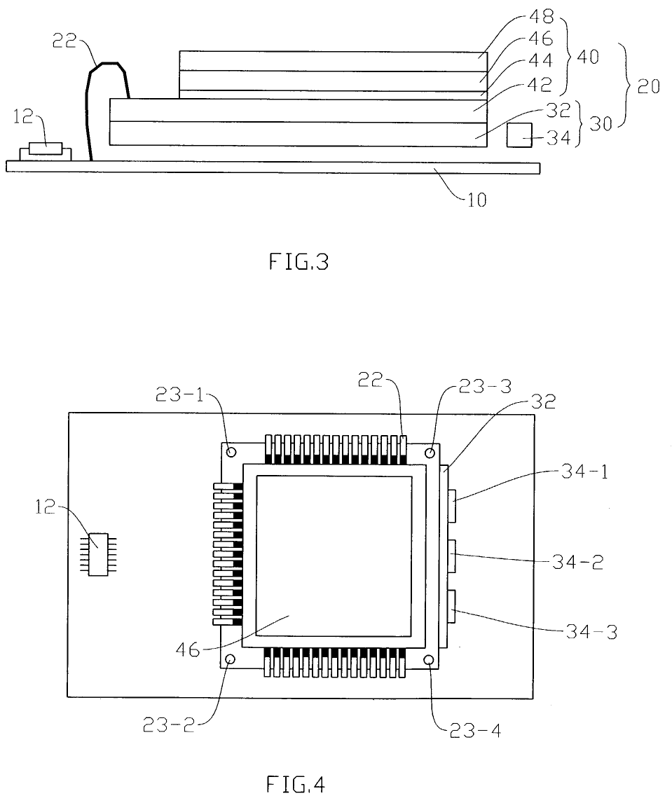

Next, An embodiment of the assembly structure of flat display device according to this invention is disclosed. As illustrated in FIG. 3, A liquid crystal display device 20 is on a system mainboard 10, wherein a control IC 12 for controlling the liquid crystal display device 20 is mounted on the system mainboard 10. The liquid crystal display device 10 comprises a back light 30 and a liquid crystal display panel 40 on the back light 30 with a light guide plate 32 and a line light source 34 located at a lateral end of light guide plate 32. The line light source 34 can be constituted with several light emitting diodes (LEDs) directly mounted on the system mainboard 10. The liquid crystal display panel 40 includes a lower transparent substrate 42 on the back light 30, a liquid crystal layer 44 on the lower transparent substrate 42, a upper transparent substrate 46 on the liquid crystal layer 44 and a polarizer 48 on the upper transparent substrate 46 in sequence. An array of thin film transistors (TFTs) (not shown in this figure), a passivation layer (not shown in this figure), and a transparent electrode layer (not shown in this figure) are sequentially formed on the lower transparent substrate 42 to constitute the lower plate of liquid crystal panel 40. Next, a color filter (not shown in this figure) and a transparent electrode layer (not shown in this figure) are sequentially formed on the upper transparent substrate 46 to constitute the upper plate of liquid crystal panel 40. Finally, The transparent electrode layers of the upper and lower plates are sealed face to face and vacuumed, and liquid crystal is injected into the space between the upper and lower plates to form the liquid crystal display panel 40.

The above process is a conventional production method to make the liquid crystal display panel, and the material of transparent substrate can be plastic, glass or other similar materials. The driver circuit of TFT on the liquid crystal display panel 40 is directly printed on the lower transparent substrate 42, so there are many pins on the edge of lower transparent substrate 42 to electrically connect with the TFT of liquid crystal display panel 40. These pins can be connected with the system mainboard 10 by the conventional method such as the direct wire bonding method. FIG. 3 is the side structure view that shows only a bonding wire 22. In fact, there are many bonding wires 22 on the edge of liquid crystal display device 20. The bonding method is not limited to the wire bonding method, but including other possible bonding methods.

FIG. 4 illustrates the top view of above embodiment. The control IC 12 is mounted on the system mainboard 10 to control the liquid crystal display device 20. There were many bonding wires 22 to connect the system mainboard 10 on the lower transparent substrate 42. The lower transparent substrate 42 can be a plastic substrate and there are four fixing holes 23 to fix the liquid crystal display device 20 and the system mainboard 10 thereon.

Moreover, the above light guide plate 32 can be used as the lower transparent substrate 42. In other words, the light guide plate 32 can be replaced with the lower transparent substrate 42. Now, the bonding method can be the solder ball bonding similar to the BGA package or the bump bonding similar to the TCP package for driver IC.

The flat display device with touch panel can be applied with this invention, too. As illustrated in FIG. 5, the lower electrode layer 52 of touch panel 50 is directly formed on the polarizer 48 of liquid crystal panel 20. In other words, the lower transparent substrate of touch panel is replaced with the polarizer 48. Then, the spacer 54′, the adhered layer 55, and the upper electrode layer 56 and the upper transparent substrate 58 can be formed in sequence by using the conventional process of touch panel. Meanwhile, a polarizer 36 can be put between the light guide plate 32 and the light source 34. The bonding wire 24,26 of touch panel 50 can be directly connected to the system mainboard 10.

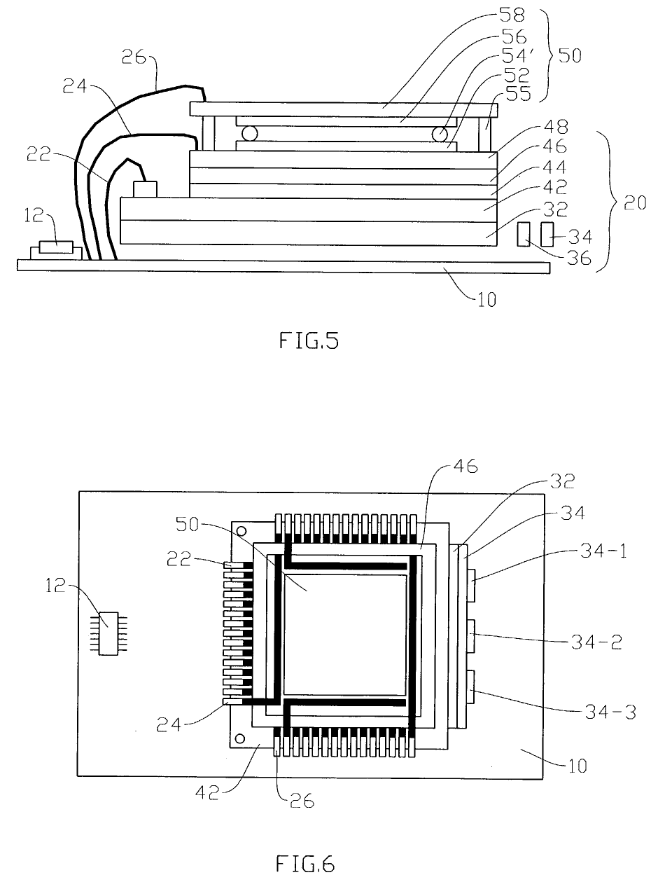

As illustrated in FIG. 6, it is a top view of liquid crystal display panel with touch panel direct bonding to system mainboard according to the embodiment of this invention. The current method that touch panel uses the silver bus design will result in the asymmetric and irregular appearance more large than the liquid crystal display device. Therefore, the contacts of touch panel 50 can be directly connected with the system mainboard 10 via the bonding wire 24,26 so as the size of touch panel can be shrunk.

There are many advantages according to the present invention. First, the FPC and the COG process can be saved by directly bonding the liquid crystal display panel to the system mainboard. Besides, It makes the whole display module lighter and thinner when the FPCs of back light and liquid crystal display panel and several connectors are replaced. And a new assembly structure for minimizing the size of flat display device with touch panel is provided.

Although the specific embodiment has been illustrated and described, it will be obvious to those skilled in the art that various modifications may be made without departing from what is intended to be limited solely by the appended claims.

What is claimed is:

1. An assembly structure for flat display device, comprising:
a liquid crystal display device including:
a back light; and
a liquid crystal display panel on said back light; and
a system mainboard with a control IC mounted thereon to control said liquid crystal display device, wherein said liquid crystal display device is on said system mainboard and said liquid crystal display panel is electrically connected to said system mainboard by a direct bonding method.

2. The assembly structure for flat display device according to claim 1, wherein said back light includes a light guide plate and a light source located at a lateral end of said light guide plate.

3. The assembly structure for flat display device according to claim 2, wherein said light source is a line LED light source.

4. The assembly structure for flat display device according to claim 3, wherein said line LED light source is mounted on said system mainboard.

5. The assembly structure for flat display device according to claim 2, wherein said liquid crystal device panel includes:
a first transparent substrate on said back light;
a liquid crystal layer on said first transparent substrate; and
a second transparent substrate on said liquid crystal layer.

6. The assembly structure for flat display device according to claim 5, wherein said second transparent substrate is used as said light guide plate of said back light.

7. The assembly structure for flat display device according to claim 5, wherein said first transparent substrate has at least a fixing hole for fixing said liquid crystal device panel on said system mainboard.

8. The assembly structure for flat display device according to claim 7, wherein the position of direct bonding said liquid crystal display panel and said system mainboard is between said first transparent substrate and said system mainboard.

9. The assembly structure for flat display device according to claim 8, wherein said direct bonding method is a wire bonding method.

10. The assembly structure for flat display device according to claim 8, wherein said direct bonding method is a Ball Grid Array (BGA) bonding method.

11. The assembly structure for flat display device according to claim 8, wherein said direct bonding method is a bump bonding method.

12. The assembly structure for flat display device according to claim 7, wherein said liquid crystal display panel includes:
a first polarizer is between said light source and said light guide plate; and
a second polarizer is on said second transparent substrate.

13. The assembly structure for flat display device according to claim 12 further comprising a touch panel on said liquid crystal display panel.

14. The assembly structure for flat display device according to claim 13, wherein said second polarizer is used as the lower transparent substrate of said touch panel.

15. The assembly structure for flat display device according to claim 14, wherein said touch panel is directly and electrically connected to said system mainboard by a wire bonding method.

16. An assembly structure for flat display device, comprising:
a liquid crystal display device including:
a back light with a light guide plate and a line LED light source located at a lateral end of said light guide plate; and
a liquid crystal display panel on said back light further comprising:
a first transparent substrate on said back light;
a liquid crystal layer on said first transparent substrate; and
a second transparent substrate on said liquid crystal layer; and
a system mainboard with a control IC mounted thereon to control said liquid crystal display device, wherein said liquid crystal display device is on said system mainboard and said first transparent substrate of said liquid crystal display panel is electrically connected to said system mainboard by a direct bonding method.

17. The assembly structure for flat display device according to claim 16, wherein said second transparent substrate is used as said light guide plate of said back light.

18. The assembly structure for flat display device according to claim 16, wherein said line LED light source is mounted on said system mainboard.

19. The assembly structure for flat display device according to claim 18, wherein said first transparent substrate has at least a fixing hole for fixing said liquid crystal device panel on said system mainboard.

20. The assembly structure for flat display device according to claim 16, wherein said liquid crystal display panel includes:
a first polarizer is between said light source and said light guide plate; and
a second polarizer is on said second transparent substrate.

21. The assembly structure for flat display device according to claim 16, wherein said direct bonding method is a wire bonding method.

22. The assembly structure for flat display device according to claim 16, wherein said direct bonding method is a Ball Grid Array (BGA) bonding method.

23. The assembly structure for flat display device according to claim 16, wherein said direct bonding method is a bump bonding method.

24. The assembly structure for flat display device according to claim 20 further comprising a touch panel on said liquid crystal display panel.

25. The assembly structure for flat display device according to claim 24, wherein said second polarizer is used as the lower transparent substrate of said touch panel.

26. The assembly structure for flat display device according to claim 25, wherein said touch panel is directly and electrically connected to said system mainboard by a wire bonding method.
